(19) United States
(12) Patent Application Publication
(10) Pub. No.: US 2008/0084592 A1
(43) Pub. Date: Apr. 10, 2008

(54) Molded Article Incorporating Volume Hologram

(75) Inventors: Eugene Pauling Boden, Scotia, NY (US); Christoph Georg Erben, Clifton Park, NY (US); Brian Lee Lawrence, Clifton Park, NY (US); Kathryn Lynn Longley, Saratoga Springs, NY (US); Xiaolei Shi, Niskayuna, NY (US); Yana Z. Williams, Schenectady, NY (US); Marc B. Wisnudel, Clifton Park, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company, Schenectady, NY (US)

(21) Appl. No.: 11/539,874

(22) Filed: Oct. 9, 2006

(51) Int. Cl. G03H 1/00

(52) U.S. Cl. 359/2; 359/15

(57) ABSTRACT

A molded article is formed by molding a holographic recording material into a shape that is determined by the function of an molded article and a volume hologram is formed in the molded article. Alternatively, only a portion of the molded article is formed from the holographic recording medium, or a molded article is formed by molding a thermoplastic into a shape that is determined by the function of the article, and then this article is then coated, for example by dip-coating, with a holographic recording medium, and al volume hologram is formed in the coating of the molded article. The hologram is one that displays an image that is directly interpretable by the human eye when properly interrogated to display an image

### BACKGROUND OF THE INVENTION

This application relates to molded articles that incorporate volume holograms, particularly for purposes of security and authentication into the molded structure of the article or as a coating on the surface thereof.

Holograms are becoming an increasingly popular mechanism for brand protection and for the authentication of genuine articles. The use of holograms for this purpose is driven primarily by the relative difficulty with which they can be duplicated. Holograms are created by interfering two coherent beams of light to create an interference pattern and storing that pattern in a holographic recording medium. Information or imagery can be stored in a hologram by imparting the data or image to one of the two coherent beams prior to their interference. The hologram can be read out by illuminating it with beams matching either of the two original beams used to create the hologram and any data or images stored in the hologram will be displayed. As a result of the complex methods required to record holograms, their use for authentication can be seen on articles such as credit cards, software, and clothing, for example.

Holograms are known of two different types of structures: surface relief structures and volume holograms. Many of the holograms used in security or authentication applications are of the surface relief type, in which the pattern and any data or image contained therein is stored in the structure or deformations imparted to the surface of the recording medium. As a result, the first recorded hologram may be created by the interference of two coherent beams, but duplicates can be created by copying the surface structure using techniques such as embossing. The duplication of holograms is convenient for the mass production of articles such as credit cards or security labels, but it also has the disadvantage that it makes the unauthorized duplication and/or modification of these holograms for use in counterfeit parts possible from the originals sing the same mechanism.

Unlike surface holograms, volume holograms are formed in the bulk of a recording medium. Volume holograms have the ability to be multiplexed, storing information at different depths and different angles within the bulk recording material and thus have the ability to store greater amount of information. In addition, because the pattern which makes up the hologram is embedded, copying cannot be done using the same techniques as for surface relief holograms.

U.S. Patent Application No. US2005/0248817 A1 entitled “Covert Hologram Design, Fabrication, and Optical Reconstruction For Security Applications,” describes a method for constructing an article with covert holograms for security applications. According to the patent application, the article is a laminate of multiple layers one or more of which is a holographic recording medium composed of photopolymer materials, and another of which is a protective layer. The holographic recording medium allows volume holograms contain digital data formatted in a two-dimensional page format to be recorded. The volume holograms containing the digital data are not visible to the naked eye because the light used to read the data is of a wavelength invisible to the naked eye, or because the diffraction efficiency of the hologram is low enough that the diffracted light containing the digital data is not strong enough to be detected by the human eye. The article may also include holograms that are both visible and invisible (or covert) and the digital data is machine-readable. Furthermore, the holographic recording layer may contain multiplexed holograms. The authentication system for articles containing holograms as described in the application comprises a complex intervening optical system, for example a spherical afocal telescopic system comprising a multiplicity of optical elements.

### SUMMARY OF THE INVENTION

The present invention provides a simpler approach to the use of volume holograms for the confirmation of authenticity and other security applications that requires no special reading system, and which can be evaluated without the assistance of a computerized reader. In accordance with a first embodiment of the invention, a molded article is formed by molding a holographic recording material into a shape that is determined by the function of the article, and a volume hologram is formed in the molded article. In a second embodiment of the invention, only a portion of the molded article is formed from the holographic recording medium. In accordance with a third embodiment of the invention, a molded article is formed by molding a thermoplastic into a shape that is determined by the function of the article, and then this article is then coated, for example by dip-coating, with a holographic recording medium, and a volume hologram is formed in the coating of the molded article. In a fourth embodiment of the invention, only a portion of the molded article is coated with the holographic recording medium.

In each of these four embodiments, the hologram is one that displays an image that is directly interpretable by the human eye when properly interrogated to display an image. Thus, the hologram does not merely display digital data that requires a machine reading system to effectively interpret the content and meaning of the stored information. Rather, the hologram provides an image of, for example a picture, or of information presented in standard alphanumeric format such as a serial number.

In some embodiments of the invention, the hologram is a covert hologram which is not visible in the absence of an interrogating beam. In other embodiments, the hologram is formed near the surface of volume of recording material and is visible to the naked eye.

In some embodiments of the invention, the hologram includes an phase-encoded encrypted image, or both an encrypted and a non-encrypted image.

In some embodiments, the angular tolerance for displaying the hologram is high, such that hand-held lasers (such as laser pointers) can be used and aligned by hand to read the holograms out of a device.

### BRIEF DESCRIPTION OF THE DRAWINGS

FIGS. 1A and B show a part molded from holographic material and molded part coated with holographic material, respectively.

FIG. 2 shows a holographic recording system in transmission geometry shown in-line in manufacturing process and shown with optional phase-mask for encoding of reference beam.

FIG. 3 shows a holographic recording system in reflection geometry shown in-line in manufacturing process and shown with optional phase-mask for encoding of reference beam.

FIGS. 4A and B show methods for limiting hologram thickness in coated parts and in molded parts, respectively.

FIGS. 5A and B show multilayer holographic security features whereby an unencoded reference beam only shows diffraction while an encoded reference beam shows the serial number.

FIG. 6 shows a holographic recording system used to record a logo image hologram in an injection-molded disc for authentication

FIG. 7 shows simple authentication system used to view the logo hologram formed as shown in FIG. 6 in authentic injection-molded discs.

FIG. 8 shows a Bragg detuning curve for a volume hologram.

### DETAILED DESCRIPTION OF THE INVENTION

The present invention relates to molded articles having a shape determined by the function of the article. In general, the molded article may be anything that is made from a moldable polymeric material (for example polycarbonate, polyester, etc) where it is desirable to provide confirmation of the authenticity of the article. By way of non-limiting example, such molded articles may be housings for communications devices such as radios, cellular telephones and the like, housings for electronic equipment such as test devices, music players and recorders, and the like. Authentication can also be extended to media discs themselves (for example CDs DVDs etc), frames for eyewear (such as sunglasses), and plastic components used in brand/logo tags, or more covertly as zippers or clasps on items such as purses or shoes.

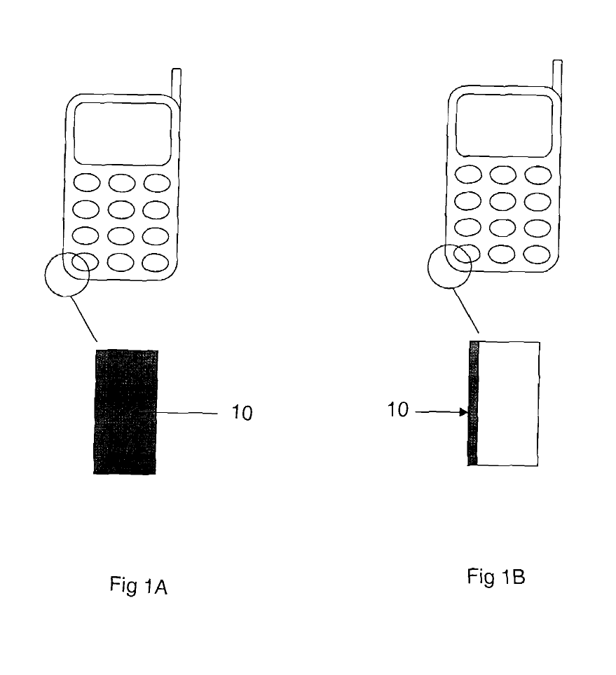

The article of the present invention is at least partially formed from or at least partially coated with a holographic recording medium in which a volume hologram can be formed. FIG. 1A shows a cellular telephone housing in which the entire molded housing is formed from a holographic recording medium 10. FIG. 1B shows a cellular telephone housing in which the housing is coated in a holographic recording medium 10.

One type of suitable holographic recording medium for use in the present invention are dye-doped thermoplastic holographic materials. Materials of this type are described in commonly assigned US Patent Publications US 2005/0136333, 2006/0078802 and 20060073392, all of which are incorporated herein by reference, for use in the storage of digital data.

In some embodiments, the holographic recording medium comprises a substrate and a dye material possessing narrowband optical properties selected and utilized on the basis of several important characteristics including the ability to change the refractive index of the dye material upon exposure to light; the efficiency with which the light creates the change; and the separation between the maximum absorption of the dye and the desired wavelength or wavelengths to be used for writing and/or reading the image. The substrate utilized in the holographic storage media of this embodiment can comprise any material having sufficient optical quality, e.g., low scatter, low birefringence, and negligible losses at the wavelengths of interest, to render the data in the holographic storage material readable. Generally, any plastic that exhibits these properties can he employed as the substrate. However, the plastic should be capable of withstanding the processing parameters (e.g., inclusion of the dye and application of any coating or subsequent layers, and molding into final format) and subsequent storage conditions. Possible plastics include thermoplastics with glass transition temperatures of about 100 C or greater, with about 150 C or greater preferred. In some embodiments, the plastic materials have glass transition temperatures greater than about 200 C, such as polyetherimides, polyimides, combinations comprising at least one of the foregoing plastics, and others. Some possible examples of these plastic materials include, but are not limited to, amorphous and semi-crystalline thermoplastic materials and blends such as: polycarbonates, polyetherimides, polyvinyl chloride, polyolefins (including, but not limited to, linear and cyclic polyolefins and including polyethylene, chlorinated polyethylene, polypropylene, and the like), polyesters, polyamides, polysulfones (including, but not limited to, hydrogenated polysulfones, and the like), polyimides, polyether sulfones, ABS resins, polystyrenes (including, but not limited to, hydrogenated polystyrenes, syndiotactic and atactic polystyrenes, polycyclohexyl ethylene, styrene-co-acrylonitrile, styrene-co-maleic anhydride, and the like), polybutadiene, polyacrylates (including, but not limited to, polymethylmethacrylate (PMMA), methyl methacrylate-polyimide copolymers, and the like), polyacrylonitrile, polyacetals, polyphenylene ethers (including, but not limited to, those derived from 2,6-dimethylphenol and copolymers with 2,3,6-trimethylphenol, and the like), ethylene-vinyl acetate copolymers, polyvinyl acetate, ethylene-tetrafluoroethylene copolymer, aromatic polyesters, polyvinyl fluoride, polyvinylidene fluoride, and polyvinylidene chloride.

The dye materials utilized in this embodiment of the invention are suitably organic dyes which undergo an irreversible chemical change upon exposure to certain “write” wavelengths of light which eliminates the absorption band exhibited by the dye. The photoproduct or photoproducts which result from interaction of the photochemically active narrowband dye with light having the “write” wavelength typically exhibits an absorption spectrum (spectra) which is entirely different from that exhibited by the dye prior to irradiation. The irreversible chemical change in the dye produced by interaction with light of the write wavelength produces a corresponding change in the molecular structure of the dye, thereby producing a “photoproduct” which may be a cleavage-type photoproduct or a rearrangement type photoproduct. This modification to the structure of the dye molecule and concurrent changes in the light absorption properties of the photoproduct(s) relative to the starting narrowband dye produces a significant change in refractive index within the substrate that can be observed at a separate “read” wavelength. The narrowband dye materials utilized according to the present disclosure also tend to have strong optical characteristics due to conservation of oscillator strength, i.e., because the absorption is localized to a narrow spectral region, the magnitude of the absorption is stronger as the area under the curve (the oscillator strength) is conserved. Specific examples of such dyes are nitrostilbene and nitrostilbene derivative such as 4-dimethylamino-2′,4′-dinitrostilbene, 4-dimethylamino-4′-cyano-2′-nitrostilbene, 4-hydroxy-2′,4′-dinitrostilben-e, and 4-methoxy-2′,4′-dinitrostilbene. These dyes have been synthesized and optically induced rearrangements of such dyes have been studied in the context of the chemistry of the reactants and products as well as their activation energy and entropy factors. J. S. Splitter and M. Calvin, “The Photochemical Behavior of Some o-Nitrostilbenes,” J. Org. Chem., vol. 20, pg. 1086(1955). More recent work has focused on using the refractive index modulation that arises from these optically induced changes to write waveguides into polymers doped with the dyes. McCulloch, I. A., “Novel Photoactive Nonlinear Optical Polymers for Use in Optical Waveguides,” Macromolecules, vol. 27, pg. 1697 (1994).

The holographic record composition may also be a mixture of a photoactive material, a photosensitizer and a moldable or coatable organic binder material, wherein the photoactive material undergoes a change in color upon reaction with the photosensitizer.

Suitable materials for use as the photosensitive materials in such mixtures include without limitation anthraquinones and their derivatives; croconines and their derivatives; monoazos, disazos, trisazos and their derivatives; benzimidazolones and their derivatives; diketo pyrrole pyrroles and their derivatives; dioxazines and their derivatives; diarylides and their derivatives; indanthrones and their derivatives; isoindolines and their derivatives; isoindolinones and their derivatives; naphtols and their derivatives; perinones and their derivatives; perylenes and their derivatives; ansanthrones and their derivatives; dibenzpyrenequinones and their derivatives; pyranthrones and their derivatives; bioranthorones and their derivatives; isobioranthorone and their derivatives; diphenylmethane, and triphenylmethane type pigments; cyanine and azomethine type pigments; indigoid type pigments; bisbenzoimidazole type pigments; azulenium salts; pyrylium salts; thiapyrylium salts; benzopyrylium salts; phthalocyanines and their derivatives, pryanthrones and their derivatives; quinacidones and their derivatives; quinophthalones and their derivatives; squaraines and their derivatives; squarilyiums and their derivatives; leuco dyes and their derivatives, deuterated leuco dyes and their derivatives; leuco-azine dyes; acridines; di-and tri-arylmethane, dyes; quinoneamines; o-nitro-substituted arylidene dyes, aryl nitrone dyes, and combinations of such materials.

The photsensitizer is suitably a photoactivatable oxidant, a one photon photosensitizer, a two photon photosensitizer, a three photon photosensitizer, a multiphoton photosensitizer, an acidic photosensitizer, a basic photosensitizer, a salt, a dye, a free radical photosensitizer, a cationic photosensitizer, or a combination comprising at least one of the foregoing photo sensitizers. By way of non-limiting example, the photsensitizer may be a hexaarylbiimidazole compound, a semiconductor nanoparticle, a halogenated compound having a bond dissociation energy effective to produce a first halogen as a free radical of not less than about 40 kilocalories per mole, a sulfonyl halide, R—SO₂—X wherein R is a member of the group consisting of alkyl, alkenyl, cycloalkyl, aryl, alkaryl, and aralkyl and X is chlorine or bromine, a sulfenyl halide of the formula R′—S—X′ wherein R′ and X′ have the same meaning as R and X, a tetraaryl hydrazine, a benzothiazolyl disulfide, a polymethacrylaldehyde, an alkylidene 2,5-cyclohexadien-1-one, an azobenzyl, a nitroso, alkyl (T1), a peroxide, a haloamine, or a combination comprising at least one of the foregoing photosensitizer. The photosensitizer may also be an acetophenone, a benzophenone, an aryl glyoxalate, an acylphosphine oxide, a benzoin ether, a benzil ketal, a thioxanthone, a chloroalkyltriazine, a bisimidazole, a triacylimidazole, a pyrylium compound, a sulfonium salt, an iodonium salt, a mercapto compond, a quinone, an azo compound, an organic peroxide or a combination comprising at least one of the foregoing photosensitizers.

The organic binder is suitably a thermoplastic polymer, a thermosetting polymer, or a combination of a thermoplastic polymer with a thermosetting polymer. For example, the organic binder material may comprise a polyacrylate, a polymethacrylate, a polyester, a polyolefin, a polycarbonate, a polystyrene, a polyamideimide, a polyarylate, a polyarylsulfone, a polyethersulfone, a polyphenylene sulfide, a polysulfone, a polyimide, a polyetherimide, a polyetherketone, a polyether etherketone, a polyether ketone ketone, a polysiloxane, a polyurethane, a polyether, a polyether amide, or a polyether ester, or a combination thereof. The organic binder may also comprise a thermosetting polymer such as an epoxy, a phenolic, a polysiloxane, a polyester, a polyurethane, a polyamide, a polyacrylate, a polymethacrylate, or a combination comprising at least one of the foregoing thermosetting polymers. The holographic recording medium may also be a combination of a photochromic compound and a moldable or curable hinder material as described above. Non-limiting examples of photochromic dyes are a diarylethene, a nitrone or a combination thereof. Specific diarylethene include without limitation diarylperfluorocyclopentenes, diarylmaleic anhydrides, diarylmaleimides Specific nitrones include, without limitation, α-(4-diethylaminophenyl)-N-phenylnitrone; α-(4-diethylaminophenyl)-N-(4-chlorophenyl)-nitrone, α-(4-diethylaminophenyl)-N-(3,4-dichlorophenyl)-nitrone, α-(4-diethylaminophenyl)-N-(4-carbethoxyphenyl)-nitrone, α-(4-diethylaminophenyl)-N-(4-acetylphenyl)-nitrone, α-(4-dimethylaminophenyl)-N-(4-cyanophenyl)-nitrone, α-(4-methoxyphenyl)-N-(4-cyanophenyl)nitrone, α-(9-julolidinyl)-N-phenylnitrone, α-(9-julolidinyl)-N-(4-chlorophenyl)nitrone, α-[2-(1,1-diphenylethenyl)]-N-phenylnitrone, α-[2-(1-phenylpropenyl)]-N-phenylnitrone, or the like, or a combination comprising at least one of the foregoing nitrones.

In the molded articles of the invention, a volume hologram is formed in the holographic recording medium. This volume hologram displays an image that is directly interpretable by the human eye when interrogated with an effective interrogating beam. As used herein, the phrase “directly interpretable by the human eye” indicates that the hologram has the form of an image such as a picture or alphanumeric text or other grouping or readily distinguished symbols, as opposed to a presentation of data which cannot be realistically interpreted without the aid of a reading machine/computer. The phrase “interrogated with an effective interrogating beam” refers to applying a laser beam of appropriate wavelength based upon the wavelength used in the recording of the hologram, and with a beam of appropriate phase when the image is phase-encoded, at an angle that results in the display of an image.

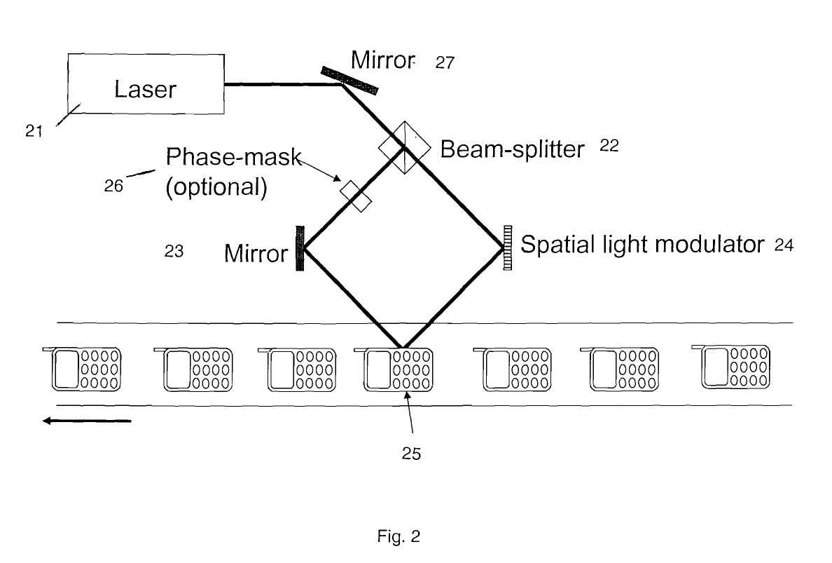

FIG. 2 shows a configuration for recording a holographic image in the cellular telephone housing in a transmission geometry. A laser 21 provides a beam of coherent radiation to a beam splitter 22 which splits the bam to direct it to a minor 23 and spatial light modulator 24 which redirect the beam to a target such a molded article 25 for recording of the hologram. Optional phase mask 26 may be inserted in the reference beam after the beam splitter 22 if a phase-encoded encrypted hologram is desired. Additional optical components represented by minor 27 may be inserted in the beam path to direct it in the desired manner, but are no required. As is known in the art, the spatial light modulator 24 imposes the image to be imparted to the hologram on the beam that reflects from this surface.

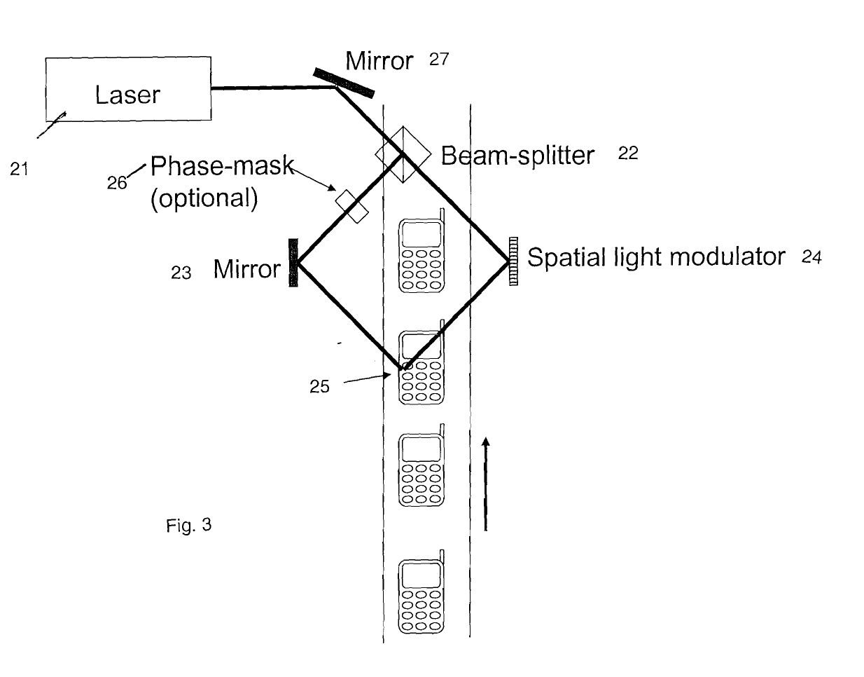

FIG. 3 shows a holographic recording system similar to that in FIG. 2 but configured such that the hologram is formed with a reflection rather than a transmission geometry. The reference numerals in FIG. 3 are the same as in FIG. 2.

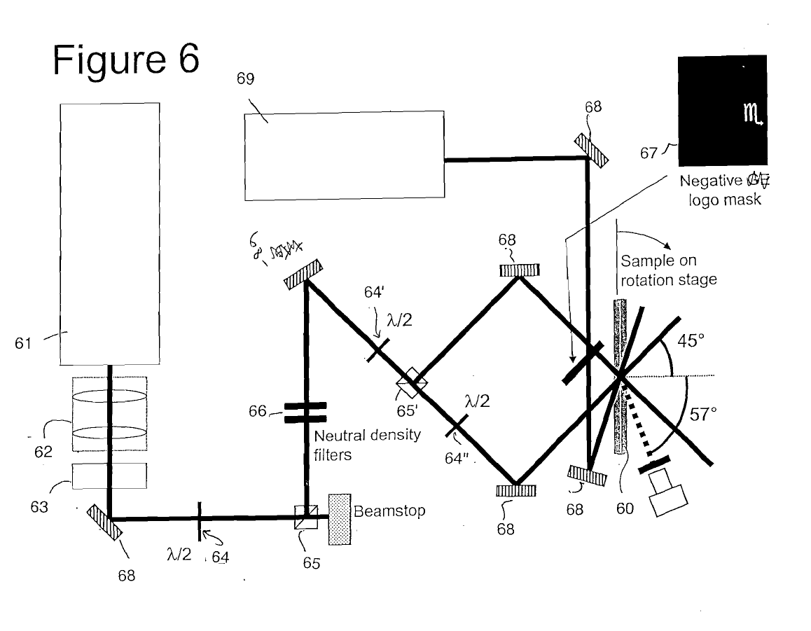

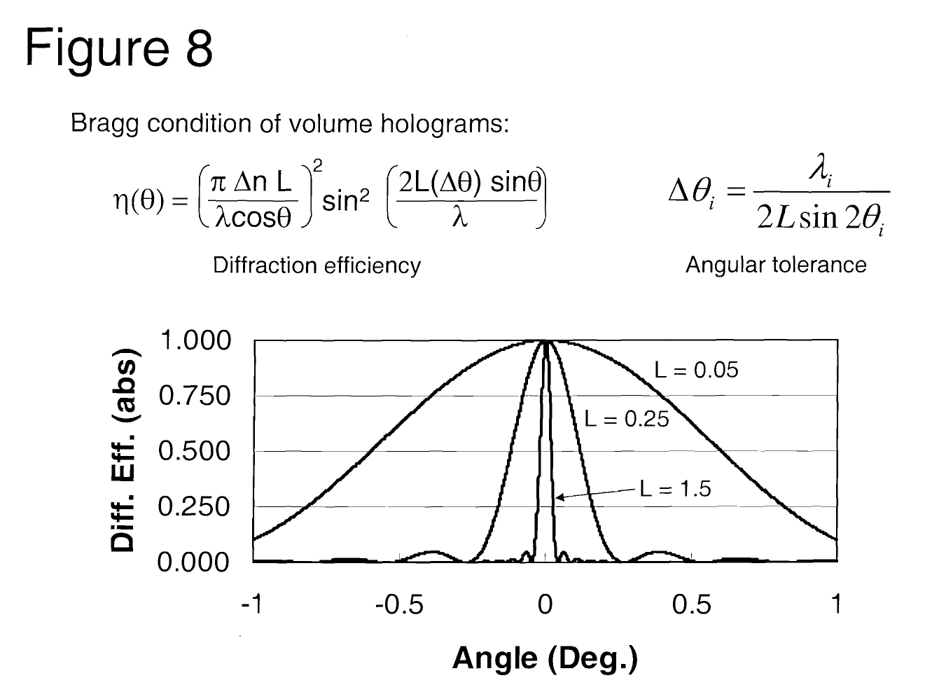

Depending on the application, it may be desirable to have the holographic image invisible to the naked eye or visible to the naked eye, or to the image provide a combination of both visible and invisible components. This is generally controlled by way of the material thickness. The Bragg detuning curve (see the equations in FIG. 8) determines the angular (and wavelength) tolerance of a volume hologram. To make a hologram more easily visible to the naked eye, the hologram needs to be thinner so that it responds to light over a broader range of wavelengths and angles. The graph in FIG. 8 shows the calculated angular tolerance of a volume hologram recorded using two beams interacting at 90 degrees (as shown in FIG. 6) for three different thicknesses: 1.5 mm, 0.25 mm, and 0.05 mm.

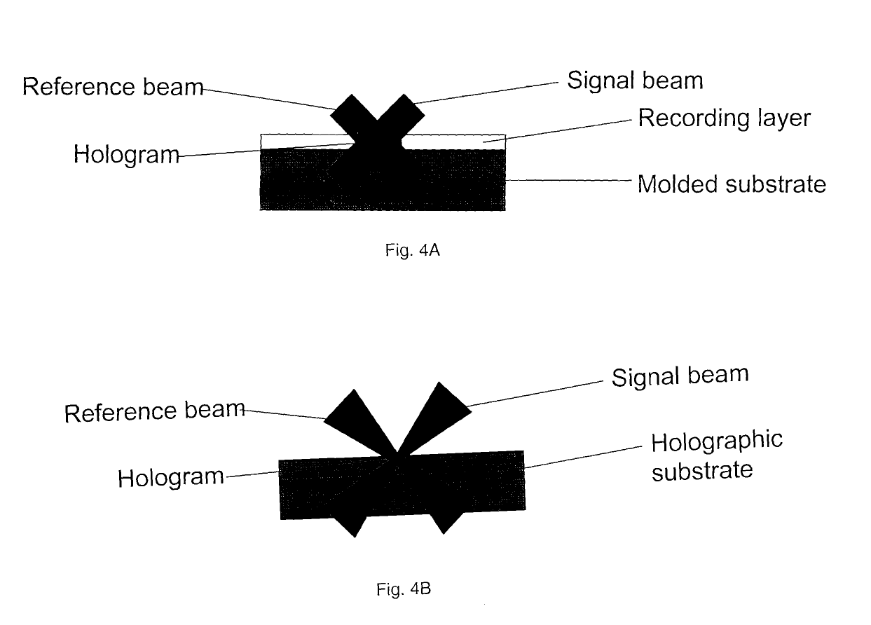

The hologram thickness can be controlled via a number of methods. FIGS. 4A and B show methods for controlling hologram thickness in coated parts and in molded parts. As shown in FIG. 4A, when the holographic material has a defined thickness, as in a coating of holographic recording material, the, maximum thickness of the hologram is defined by the layer thickness, even though the beams may overlap over a larger thickness. Conversely, in a volume hologram formed in a thicker material (such as a molded article formed from the holographic recording medium) the thickness can he controlled by modifying the recoording conditions to limit the overlap of the recording beams. For example, the overlap of two focused beams can be controlled to record over a desired thickness as shown in FIG. 4B.

When the hologram is invisible, the image will only he properly displayed when the hologram is interrogated with an appropriate beam, that matches the reference beam in wavelength, incidence angle and phase alterations, if any. To facilitate the reading of the hologram without expensive additional equipment, it is desirable to match the wavelength of the reference beam to commonly available handheld laser pointers, such as HeNe red laser pointers. In addition, it is desirable to record the hologram in a manner that maximizes the angular tolerance for display so that no special alignment tools need to be used. As described above, this is achieved by controlling the thickness of the hologram. To facilitate use of a handheld laser pointer, it is desirable to hive an angular tolerance (the angle by which the incidence angle can depart from the actual recording angle and still result in an image) of at least 0.5 degrees. As indicated in FIG. 8, such angular tolerances can he achieved when the hologram has a thickness of approximately 0.1 mm. Hologram thickness of 0.05 mm results in angular tolerances of greater than +/−1 degree (null-to-null).

The specific content of the hologram imparted in the molded article of the present invention depends on the needs of the user, with the proviso that in the articles of the invention this content always includes an image that is directly interpretable by the human eye when properly interrogated to display an image. In addition to this image, the hologram may also include digital data, or a multiplicity of images.

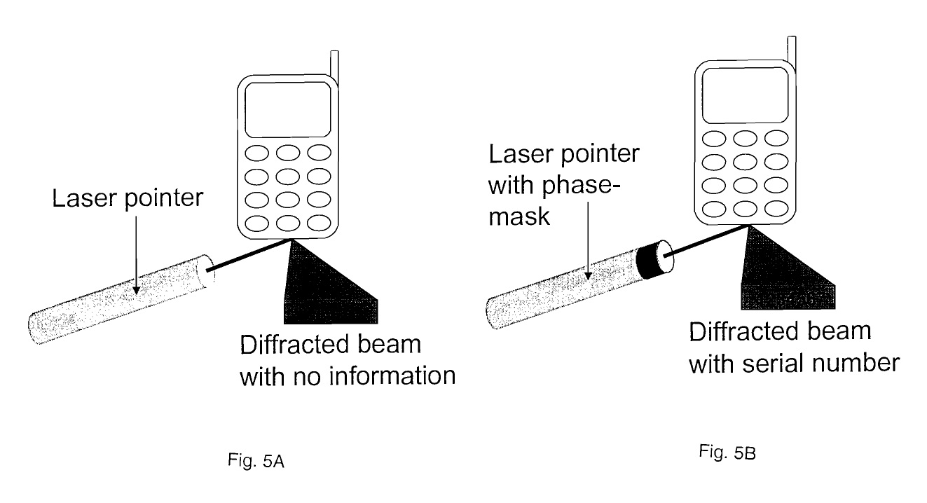

As depicted in FIG. 5B, the molded article of the invention may display an image of an alphanumeric identifier when properly interrogated. In FIG. 5B, the image is of a serial number, however, other types of identifiers or information may also be included in alphanumeric format, such as lot numbers, part numbers, or process conditions.

In FIG. 5B, the image is one that is displayed only when the appropriate phase mask is affixed on the laser pointer, and thus one which is a phase-encoded or an encrypted readout. In this case, the holographic recording may also provide an unencrypted readout, which contains no information (resulting in a diffracted box) or a different image, either one of which can be used to demonstrate authenticity, as reflected in FIG. 5A. Phase encoding as can be achieved by inserting a phase mask into either the reference beam or the object beam, as described in U.S. Pat. Nos. 6,002,773, and 6,744,909 and US Patent Publication 20040101168 which are incorporated herein by reference.

The present invention further provides a method for making a molded article incorporating a volume hologram, The method comprises the steps of: (a) molding an article from a hologtraphic recording medium, and (b) writing a volume hologram in the molded article, wherein the volume hologram displays an image that is directly interpretable by the human eye when interrogated with an effective interrogating beam. The molding of the article may be performed by any of the numerous molding methods known in the art, including without limitation injection molding,

The present invention also provides a method for making a molded article incorporating a volume hologram, comprising the steps of: (a) molding an article from a thermoplastic material; (b) coating the molded article in a hologtraphic recording medium, and (c) writing a volume hologram in the coating of holographic recording medium, wherein the volume hologram displays an image that is directly interpretable by the human eye when interrogated with an effective interrogating beam. The cloating process can be by any method, including for example spray coating and dip coating provided it provides a reproducible coating thickness onto the base molded article.

### EXAMPLE

As an example of the present invention a 120 mm diameter, 1.2 mm thick disc 60 with optical quality front and back surfaces was injection molded from a holographic recording material. The material was an optical quality polystyrene containing about 1 weight % of the extended-CEM-388 nitrone dye shown below:

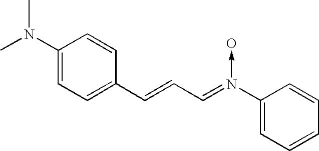

The disc 60 was placed at the sample location of the recording system shown in FIG. 6. A diode pumped solid-state (DPSS), single longitudinal mode (SLM), intra-cavity frequency-doubled, Nd:YAG laser 61 was used as the source, producing up to 300 mW of coherent laser light at 532 nm. The beam output by the laser source has a beam diameter of approximately 0.8 mm and an expanding telescope 62 was used to increase the beam diameter to approximately 8 mm. A mechanical shutter 63 was used to control recording exposure times. The expanded beam was then passed through a hall-waveplate 64 and polarizing beam-splitter 65 to control the power level of the light going into the recording setup and neutral density filters 66 were used to provide rapid adjustment of the power level in discrete factors of 10. A second half waveplate 64′ and polarizing beam-splitter 65′ were then used to split the incoming beam into two beams of equal power. An additional half waveplate 64″ is used in the reference beam path to adjust the polarization of the reference beam to be identical to the signal beam. A negative amplitude mask of a logo (in this case dark field with transparent logo) 67 was placed in the signal beam at normal incidence to the laser beam and as close to the disc 60 as possible. Mirrors 68 were used to direct the beam between the various optical components.

The signal and reference beams were incident into the disc 60 with an angle of 45 degrees with respect to the disc. The power level of the light was adjusted such that both the signal and reference beams had 14 mW of power. The shutter 63 was then opened to expose the disc to the recording light for 12 to 15 seconds. For evaluation a red HeNe laser 69 producing 1-3 mW of laser light at 633 nm was used to measure the efficiency of the recorded hologram. Under the described recording conditions, holograms of 12% to 15% diffraction efficiency were achieved. The location of the hologram was then indicated on the disc and the disc was removed from the recording system.

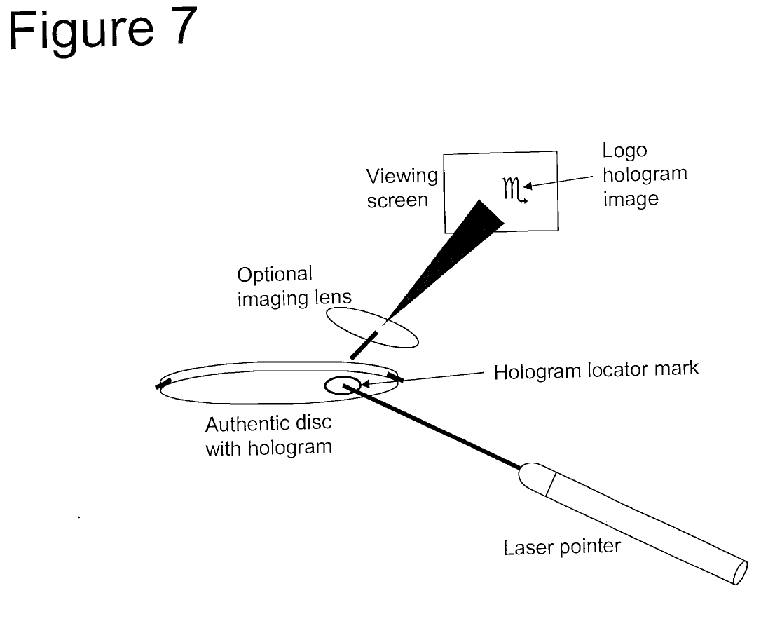

For read out of the logo hologram a second system was used. The read out or authentication system is shown in FIG. 7. In this system, a battery-operated laser pointer producing 5 mW of laser light at 650 nm was used as the illuminating source. The disc to be authenticated was placed in a sample mount located on a rotation stage and the laser pointer was aligned such that the laser beam was incident on hologram location, previously marked during the recording process. The rotation stage was used to align the disc to the appropriate angle to read out the hologram. When properly aligned and illuminated by the laser pointer, an authentic disc produced a general electric logo image out of the side of the disc opposite to the laser pointer. The logo image was approximately 3 mm in diameter. A single optional imaging lens may be placed immediately behind the disc to be authenticated to make the logo image more easily viewable by the naked eye. The observation of the logo image from the disc indicated an authentic disc.

What is claimed is:

1. A molded article having a shape determined by the function of the article, wherein the article is at least partially formed from or at least partially coated with a holographic recording medium, and wherein:
(a) a volume hologram is formed in the holographic recording medium, and
(b) the volume hologram displays an image that is directly interpretable by the human eye when interrogated with an effective interrogating beam.

2. The molded article of claim 1, wherein the volume hologram comprises an image of an alphanumeric identifier.

3. The molded article according to claim 2, wherein the image of alphanumeric identifier is not visible in the absence of an effective interrogating beam.

4. The molded article of claim 3, wherein the image of the alphanumeric identifier is a phase-encoded encrypted image.

5. The molded article of claim 1, wherein the image is not visible in the absence of an effective interrogating beam.

6. The molded article of claim 5, wherein the image is a phase-encoded encrypted image.

7. The molded article of claim 6, further comprising a non-encrypted image.

8. The molded article of claim 7, wherein the non-encrypted image is not visible in the absence of an effective interrogating beam.

9. The molded article of claim 1, wherein the angular tolerance for displaying the hologram is at least 0.5 degrees.

10. The molded article of claim 9, wherein the volume hologram comprises an image of an alphanumeric identifier.

11. The molded article according to claim 10, wherein the image of alphanumeric identifier is not visible in the absence of an effective interrogating beam.

12. The molded article of claim 11, wherein the image of the alphanumeric identifier is a phase-encoded encrypted image.

13. The molded article of claim 9, wherein the image is not visible in the absence of an effective interrogating beam.

14. The molded article of claim 13, wherein the image is a phase-encoded encrypted image.

15. The molded article of claim 14, further comprising a non-encrypted image.

16. The molded article of claim 15, wherein the non-encrypted image is not visible in the absence of an effective interrogating beam.

17. The molded article of claim 9, wherein the article is at least partially formed from the holographic recording medium.

18. The molded article of claim 9, wherein the article is at least partially coated in the holographic recording medium.

19. The molded article of claim 1, wherein the article is at least partially formed from the holographic recording medium.

20. The molded article of claim 9, wherein the article is at least partially coated in the holographic recording medium.

21. A method for making a molded article incorporating a volume hologram, comprising the steps of:
(a) molding an article from a hologtraphic recording medium, and
(b) writing a volume hologram in the molded article, wherein the volume hologram displays an image that is directly interpretable by the human eye when interrogated with an effective interrogating beam.

22. The method of claim 21, wherein the volume hologram comprises an image of an alphanumeric identifier.

23. The method of claim 22, wherein the image of alphanumeric identifier is not visible in the absence of an effective interrogating beam.

24. The method of claim 23, wherein the image of the alphanumeric identifier is a phase-encoded encrypted image.

25. A method for making a molded article incorporating a volume hologram, comprising the steps of:
(a) molding an article from a thermoplastic material;
(b) coating the molded article in a hologtraphic recording medium, and
(c) writing a volume hologram in the coating of holographic recording medium, wherein the volume hologram displays an image that is directly interpretable by the human eye when interrogated with an effective interrogating beam.

26. The method of claim 25, wherein the volume hologram comprises an image ot an alphanumeric identifier.

27. The method of claim 26, wherein the image of alphanumeric identifier is not visible in the absence of an effective interrogating beam.

28. The method of claim 27, wherein the image of the alphanumeric identifier is 1 phase-encoded encrypted image.
